(19) United States
(12) Patent Application Publication
(10) Pub. No.: US 2015/0043883 A1
(43) Pub. Date: Feb. 12, 2015

(54) OPTICAL NETWORK CABLE BOX WITH PREFORMED CABLE PORTS AND BLOCKING GATE

(71) Applicant: CORNING OPTICAL COMMUNICATIONS LLC, Hickory, NC (US)

(72) Inventors: Ray Samuel Barnes, JR., Hickory, NC (US); Trampus Lee Landrum, Hickory, NC (US); Dave Eric Cunningham, Conover, NC (US)

(21) Appl. No.: 14/451,558

(22) Filed: Aug. 5, 2014

Related U.S. Application Data
(60) Provisional application No. 61/864,203, filed on Aug. 9, 2013.

(51) Int. Cl. G02B 6/44; G02B 6/46

(52) U.S. Cl. CPC G02B 6/4446; G02B 6/46
USPC 385/135; 29/428

(57) ABSTRACT

A secure cable box for use within a fiber optic communications network including a plurality of walls defining an interior cavity is provided. The cable box includes a door moveable between opened and closed positions to provide access to the interior cavity and a preformed opening formed through one of the plurality of walls providing a passage extending between an outer surface and an inner surface of the wall. The preformed opening is sized to receive a fiber optic transmission element therethrough. The cable box includes a gate located within the interior cavity adjacent an inner end of the preformed opening, and the gate is moveable between a first position in which the gate blocks the preformed opening and a second position in which the preformed opening is unblocked.

### RELATED APPLICATIONS

This application claims the benefit of priority under 35 U.S.C. §119 of U.S. Provisional Application No. 61/864,203 filed on Aug. 9, 2013, the content of which is relied upon and incorporated herein by reference in its entirety.

### BACKGROUND

1. Field of the Disclosure

The disclosure relates generally to secure fiber optic networks and more particularly to cable boxes for secure fiber optic networks.

2. Technical Background

Within the optical network, various cable boxes (e.g., zone boxes) are used to aggregate, secure, connect and split optical cables out to end users. An optical network terminal (ONT) is a network interface device that allows connection between an optical network and another network type (e.g., Ethernet) or a particular device (e.g., a desktop computer, a telephone, fax machine, etc.). A protected distribution system (PDS) is a fiber optic communication network that includes various safeguards to permit its use for the unencrypted transmission of sensitive or classified information. For example, in a PDS, fiber optic cables may be located within hardened or armored conduit that limits physical access to the fibers. In such a PDS, the aggregation, connection or split points of the fiber optic cables may be located within a cable box that is hardened and designed to prevent unauthorized access into the cable box. In addition, the optical fibers and cable boxes within a PDS may be equipped with an alarm system such as Network Integrity's Interceptor.

### SUMMARY

One embodiment of the disclosure relates to a secure cable box for use within a secure fiber optic communications network. The secure cable box includes a bottom wall and a plurality of sidewalls coupled to the bottom wall. Each sidewall has an outer surface and an inner surface. The secure cable box includes a top wall coupled to the plurality of sidewalls, and the bottom wall, the sidewalls and the top wall define an interior cavity. The top wall is moveable between open and closed positions to provide access to the interior cavity. The cable box includes a locking mechanism configured to lock the top wall in the closed position. The cable box includes a preformed opening formed through one of the plurality of sidewalls providing a passage extending between the outer surface and the inner surface of the sidewall. The cable box includes a gate located within the interior cavity adjacent an inner end of the preformed opening. The gate is moveable between a first position and a second position. In the first position, the gate is positioned between the preformed opening and the inner cavity blocking the preformed opening, and in the second position, the preformed opening is unblocked.

An additional embodiment of the disclosure relates to a secure cable box for use within a fiber optic communications network including a plurality of walls defining an interior cavity. The cable box includes a door moveable between opened and closed positions to provide access to the interior cavity and a preformed opening formed through one of the plurality of walls providing a passage extending between an outer surface and an inner surface of the wall. The preformed opening is sized to receive a fiber optic transmission element therethrough. The cable box includes a gate located within the interior cavity adjacent an inner end of the preformed opening, and the gate is moveable between a first position in which the gate blocks the preformed opening and a second position in which the preformed opening is unblocked.

An additional embodiment of the disclosure relates to a method of installing a cable box into a secure fiber optic communication network The method includes providing an optical fiber cable box. The optical fiber cable box includes a plurality of walls defining an interior cavity, a first preformed opening extending through one of the plurality of walls and a gate located in the interior cavity. The gate is positioned in a first position adjacent an inner end of the first preformed opening blocking the first preformed opening. The method includes moving the gate from the first position to a second position unblocking the first preformed opening.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1A is a front perspective view of a secure cable box according to an exemplary embodiment.

FIG. 1B is a perspective view of the secure cable box of FIG. 1A with the lid in the closed position according to an exemplary embodiment.

FIG. 2 is a rear perspective view of the secure cable box of FIG. 1A according to an exemplary embodiment.

FIG. 3 is a top plan view of the secure cable box of FIG. 1A according to an exemplary embodiment.

FIG. 4 is a detailed cross-sectional view of the gate of the secure cable box of FIG. 1A according to an exemplary embodiment.

FIG. 5 is a rear perspective view of the interior of a secure cable box including a stress relief bracket according to an exemplary embodiment.

FIG. 6 is a detailed view of the stress relief bracket of FIG. 5 according to an exemplary embodiment.

FIG. 7 is a front perspective view of a secure cable box according to another exemplary embodiment.

FIG. 8 is a front view of a secure cable box according to another exemplary embodiment.

FIG. 9 is a top plan view of the secure cable box of FIG. 8 according to an exemplary embodiment.

FIG. 10 is a detailed top view of an optical cable and a fiber optic component connector coupled to a secure cable box according to an exemplary embodiment.

FIG. 11 is a detailed top view of an optical cable and fiber optic component coupled to a secure cable box according to another exemplary embodiment.

### DETAILED DESCRIPTION

Referring generally to the figures, various embodiments of a cable box are shown. The cable box embodiments discussed herein include a series of walls defining an interior cavity or compartment and one or more preformed entry ports or openings located through at least one of the walls of the cable box. Each preformed opening is sized to receive a fiber optic transmission element (e.g., a fiber optic cable, a fiber optic connector, etc.). Located within the cable box is a gate that blocks the preformed openings such that entry into the cable box from the outside through a blocked entry port is significantly limited or prevented.

To install a fiber optic transmission element into the cable box, a user accesses the interior of the cable box, typically by unlocking and opening a door into the cable box. The user then moves the gate to unblock each of the preformed openings that will receive a fiber optic transmission element. The user then inserts a fiber optic transmission element through each unblocked preformed opening into the cable box. Within the cable box, the fiber optic transmission element is used as needed for a particular application (e.g., connected, split, etc.).

In various embodiments, the gate may be modified (e.g., shortened) and repositioned to block any unused preformed openings. In addition, the preformed openings are sized such that the spacing or gap between the outer diameter of the fiber optic transmission element and the opening is sufficiently small to prevent access into the interior of the cable box between the cable and the opening. Thus, with fiber optic transmission elements extending through at least one of the preformed openings and with the repositioned gate blocking any unused ports, entry into the cable box through either of the openings that are occupied by fiber optic transmission elements or the unused ports is significantly limited or prevented.

The cable box embodiments including preformed openings and the gates as discussed herein may be used within a PDS. In addition, the cable box embodiments discussed herein may provide quick or simplified installation into the PDS fiber optic communication network. Typical cable boxes for a PDS include no preformed openings requiring the installer to drill cable entry ports as needed for the installation. Drilling such ports is time consuming and requires use of a precisely sized drill bit that is precisely positioned to form an entry port in the proper spot. In addition, on site drilling typically may require a power source to operate the drill. The cable box embodiments discussed herein provide fiber optic transmission element assembly into the cable box without the need of onsite drilling of entry ports while still providing sufficient security for use within a PDS.

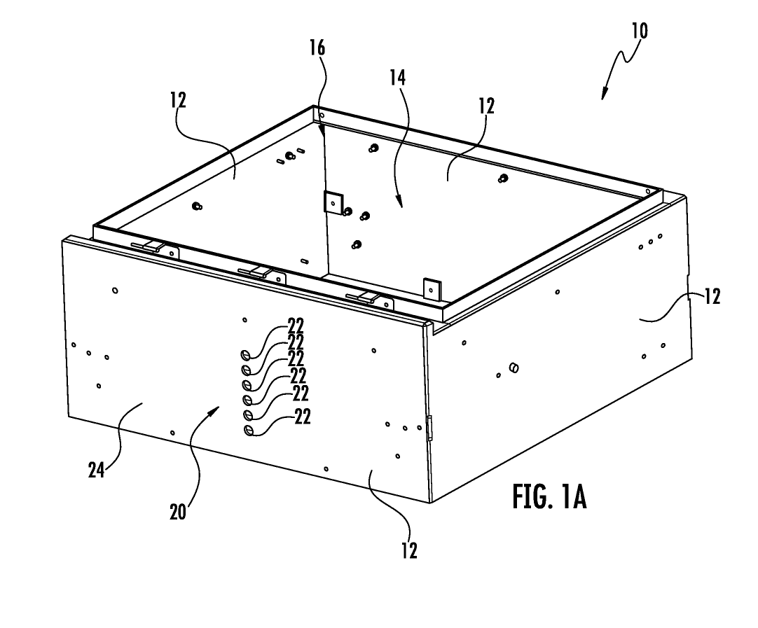

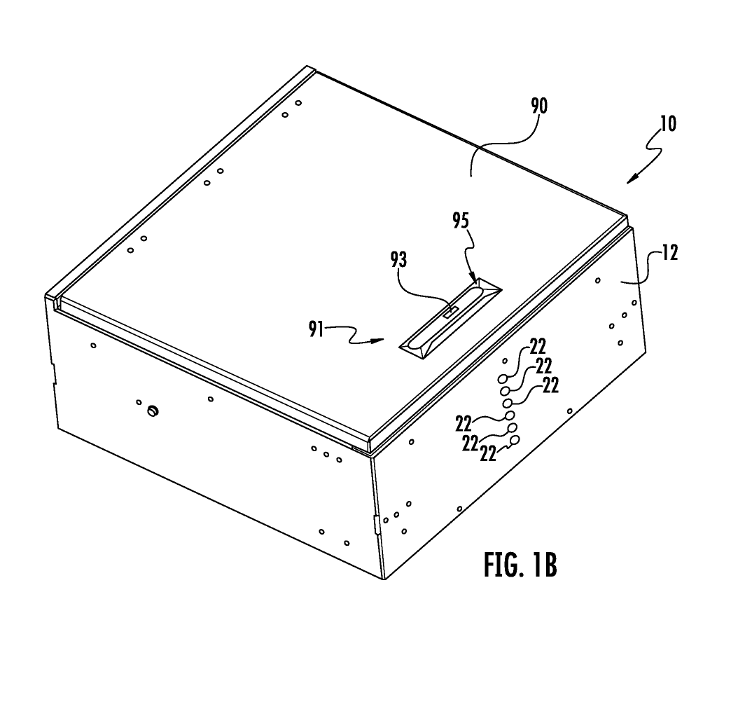

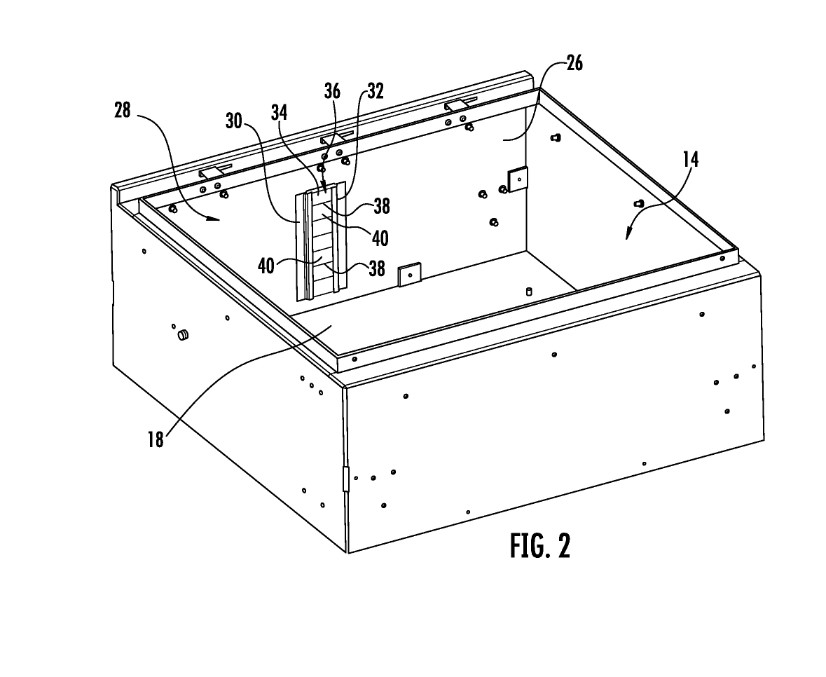

Referring to FIGS. 1-4, a cable box, shown as cable box 10, is shown according to an exemplary embodiment. Box 10 includes four sidewalls 12 and a bottom wall 18 (shown in FIG. 2). Inner surfaces of sidewalls 12 and bottom wall 18 generally define an interior cavity 14. In the orientation of FIGS. 1 and 2, the upper edges of sidewalls 12 define an upper open end 16. A top wall or lid 90 (shown in FIG. 1B) is coupled to sidewalls 12 to seal interior cavity 14 of cable box 10. For use within a PDS, lid 90 includes a locking mechanism 91 and is locked following installation of the fiber optic transmission elements into cavity 14 to prevent unauthorized access into cable box 10. In the embodiment of FIG. 1B, locking mechanism 91 includes a loop or ring 93 coupled to box 10 that extends through a slot 95 formed in lid 90, and in this embodiment, a lock, such as a pad lock, is coupled through ring 93 to secure box 10 in a locked position. In another embodiment, box 10 may include an integrated key lock or combination lock.

Referring to FIG. 1A, one of the sidewalls 12 (shown as a front sidewall in FIG. 1A), includes at least one preformed opening, shown as an array 20 of preformed holes 22. Holes 22 are ports formed through sidewall 12 such that a fiber optic transmission element (e.g., a fiber optic cable, fiber optic cable connecter, fiber optic cable splitter, etc.) is able to pass through the hole from the exterior of cable box 10 into interior cavity 14. Thus, each hole 22 defines an outer end or entry formed in the front surface 24 of sidewall 12, and an inner end or exit formed in inner surface 26 of sidewall 12. Each hole includes an inner surface extending between the entry and exit that defines the passage from the exterior of cable box 10 through sidewall 12 and into interior cavity 14. Array 20 is formed within sidewall 12 positioned between an upper edge and a lower edge of sidewall 12. In this embodiment, there is a section of sidewall 12 located above the upper most hole 22 in array 20, and there is also a section of sidewall 12 located below the lower most hole 22 in array 20.

As shown in FIG. 1A, each hole 22 is sized to receive a single fiber optic transmission element. In addition, each hole is sized such that the space between the outer surface of the fiber optic transmission element and the inner surface of the hole is sufficiently small that access to interior cavity 14 between the fiber optic transmission element and the inner surface of the hole is not permitted. In one such embodiment, the outer surface of the fiber optic transmission element engages the inner surface of the hole 22. In another embodiment, the space between the outer surface of the fiber optic transmission element and the inner surface of the hole is less than 0.00003 inches. In one embodiment, the diameter of holes 22 may be 31/64 inches plus or minus 1/32 inches. In another embodiment, the diameter of holes 22 may be 1/32 inches plus or minus 1/32 inches.

In various embodiments, box 10 may include more than one array 20 of holes 22 (e.g., 2, 3, 4, 5, etc. arrays 20). In such embodiments, the multiple arrays 20 may all be formed through the same sidewall 12, or one or more array 20 may be formed through more than one sidewall 12. The embodiment of FIG. 1A shows array 20 including six preformed holes 22. In other embodiments, array 20 may include less than six holes 22 (e.g., 1, 2, 3, 4, 5 holes 22), or more than six holes 22 (e.g., 7, 10, 12, 15, etc. holes 22). Array 20 is a vertical or columnar array of holes 22. In other embodiments, array 20 may be positioned relative to sidewall 12 in any other suitable arrangement including an angled array of holes, a square array of holes, a rectangular array of holes or a circular array of holes.

Referring to FIG. 2, a gate 28 that blocks preformed holes 22 is shown according to an exemplary embodiment. In general, the gate 28, in a first or blocking position, is located within interior cavity 14 adjacent the inner end or exit of holes 22, such that the gate 28 is positioned between one or more hole 22 and inner cavity 14, and thereby acts to block the hole 22. In such embodiments, the gate 28 physically obstructs blocked holes 22 such that insertion of an object through the blocked preformed hole 22 into interior cavity 14 is significantly limited or prevented. In addition, the gate 28 is moveable to a second position in which the previously blocked preformed hole 22 is unblocked, and thereby allowing insertion of a fiber optic transmission element through a preformed hole 22 into cavity 14.

In the embodiment shown in FIG. 2, the gate 28 includes a first bracket 30, a second bracket 32 and a barricade 34. Generally, bracket 30 and bracket 32 are coupled to inner surface 26 of sidewall 12 and extend from inner surface 26 into interior cavity 14. In this arrangement, brackets 30 and 32 include interior surfaces that define a slot 36 with a portion of inner surface 26 adjacent holes 22.

In general, barricade 34 is a wall that is positioned adjacent the inner end or exit of holes 22 that physically objects the inner end of holes 22. In the embodiment shown in FIG. 2, barricade 34 is slidably received within slot 36. As shown in FIG. 2 with barricade 34 positioned within slot 36, barricade 34 blocks holes 22 such that entry of an object (e.g., a probe, splicer, etc.) through holes 22 from the exterior of cable box 10 into cavity 14 is prevented.

Barricade 34 is a contiguous segmented piece of rigid material (e.g., metal, steel, aluminum, etc.) that includes a plurality of scores lines 38 that divide barricade 34 into a plurality of segments 40. Score lines 38 are areas of weakness in barricade 34 that allow segments 40 to be broken off of barricade 34 as needed during installation of fiber optic transmission elements into box 10. In one embodiment, score lines 38 allow segments 40 to be removed by manual force or by repeated flexing or bending to cause metal fatigue. In particular, if less than all of holes 22 of box 10 receive fiber optic transmission elements in a particular installation, a segment 40 is removed from barricade 34 for each hole 22 that receives a fiber optic transmission element. Following cable insertion into box 10, the shortened barricade 34 is reinserted into slot 36 reblocking each unused hole 22 located above the holes 22 that received a fiber optic transmission element.

In the embodiment shown in FIG. 2, score lines 38 are substantially perpendicular to the longitudinal axis of barricade 34 defining substantially rectangular segments 40. In other embodiments, score lines 38 may be shaped to substantially match the perimeter or profile of the fiber optic transmission elements that will be installed into box 10. For example, in various embodiments, score lines 38 may be curved or semi-circular in shape to match the circular profile of an optical cable or connector. Shaping score line 38 to match the profile of the fiber optic transmission elements, allows the lower edge of the shortened barricade 34 to surround a portion of the fiber optic transmission element beneath the shortened barricade. This engagement may help seal the hole 22 that received the fiber optic transmission element. In various embodiments, segments 40 of barricade 34 are formed from metal (e.g., steel or aluminum) having thickness between 11 gauge and 13 gauge. In various embodiments, the metal material of barricade 34 at score lines 38 has a thickness between 11 gauge and 13 gauge.

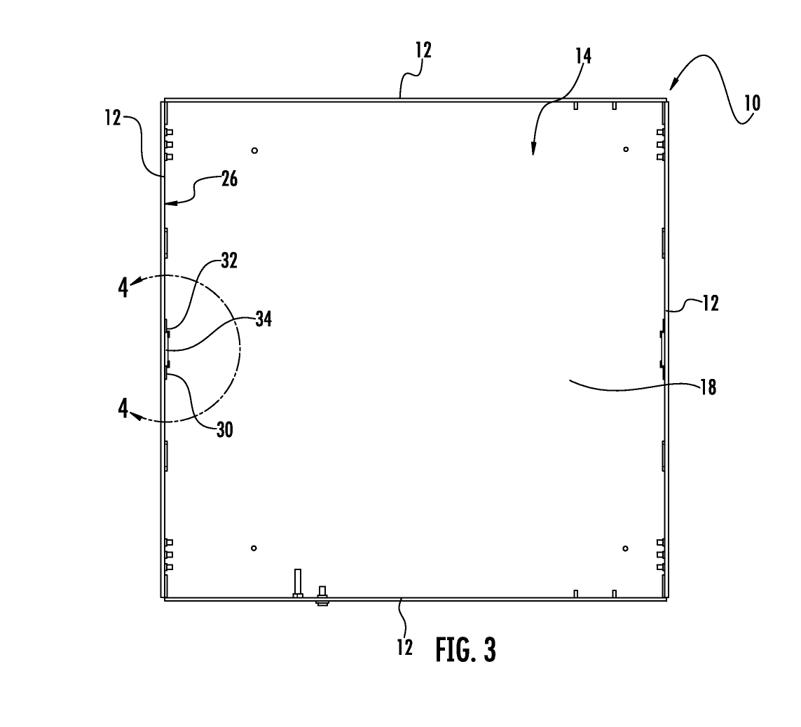

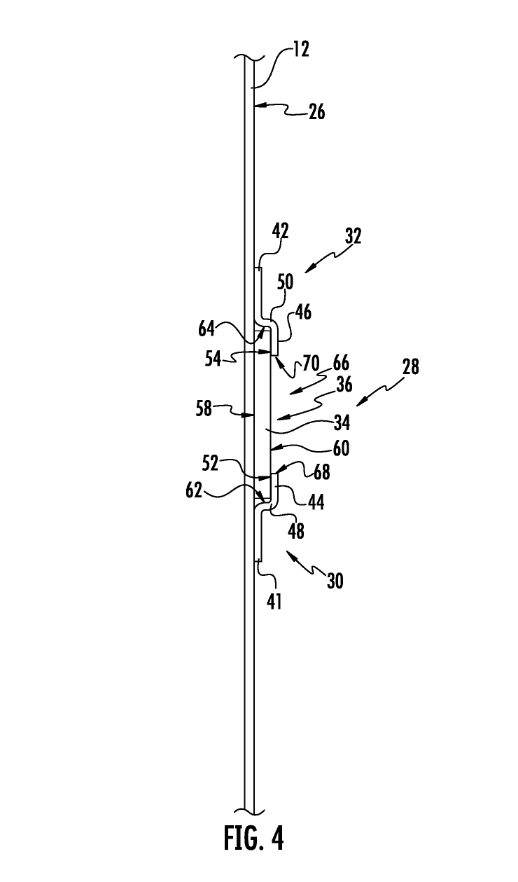

Referring to FIG. 3 and FIG. 4, bracket 30 includes a first section 41, and bracket 32 includes a first section 42. First sections 41 and 42 of brackets 30 and 32 have outer surfaces coupled to inner surface 26 of sidewall 12. Bracket 30 includes a second section 44 coupled to first section 41 by elbow section 48. Bracket 32 includes a second section 46 coupled to first section 42 by elbow section 50. Elbow sections 48 and 50 extend away from first sections 41 and 42, respectively, providing a space between inner surface 26 and second sections 44 and 46. In this arrangement, outward facing surfaces 52 and 54 of second sections 44 and 46 in combination with the portion of inner surface 26 of sidewall 12 adjacent to holes 22 define slot 36 that receives barricade 34.

In various embodiments, the depth of slot 36 (i.e., the perpendicular distance between surfaces 52 and 54 and inner surface 26 of sidewall 12) is substantially the same as the thickness of barricade 34 such that barricade 34 is moveable or slidable within slot 36 while at the same time blocking holes 22 such that entry of an object through blocked holes 22 is significantly limited or prevented. In such embodiments, barricade 34 includes an outward facing surface 58 that contacts and slidably engages inner surface 26 of sidewall 12 and an inward facing surface 60 that engages outward facing surfaces 52 and 54 of brackets 30 and 32. In addition, elbow sections 48 and 50 of brackets 30 and 32 include inner surfaces 62 and 64, respectively, that engage lateral surfaces of barricade 34 preventing or limiting lateral movement of barricade 34 within slot 36. This relatively tight fit of barricade 34 within slot 36 acts to significantly limit or prevent barricade 34 from being pushed away from holes 22 or otherwise manipulated from outside of cable box 10. In addition, a fastener (e.g., a screw) may be used to couple barricade 34 to a structure within cable box 10 (e.g., sidewall 12, bottom wall 18, brackets 30 or 32, etc.) to further resist movement of the barricade 34 from outside of cable box 10.

Brackets 30 and 32 further define an opening 66 defined by inner surfaces 68 and 70 of second sections 44 and 46. Inner surfaces 68 and 70 are positioned substantially perpendicular to inner surface 26 of sidewall 12 and face each other. Opening 66 is shown in FIG. 2, and opening 66 exposes the inner surface of barricade 34 to interior cavity 14. Opening 66 provides a space between brackets 30 and 32 such that fiber optic transmission elements received through holes 22 are able to pass freely into interior cavity 14.

In other embodiments, the gate 28 blocking holes 22 may take other forms suitable forms to block holes 22 to limit or prevent object entry into interior cavity 14. For example, in another embodiment, brackets 30 and 32 may define rings or loops that receive elongated posts extending from barricade 34 to secure barricade 34 in the blocking position. In another embodiment, brackets 30 and 32 may be coupled to and extend from bottom wall 18 rather than the inner surface of sidewall 12. In another embodiment, the sidewall 12 including preformed holes 22 may be a double walled sidewall including a slot positioned between an inner wall and outer wall of sidewall 12, and, in this embodiment, barricade 34 may slide into the slot located within sidewall 12 to block unused preformed holes 22. In another embodiment, the gate 28 may include a barricade coupled to inner surface 26 of sidewall 12 at one edge by a hinge and at the other edge by a fastener (e.g., a screw, detent, etc.). In this embodiment, the fastener is released, and the barricade is pivoted on the hinge to unblock preformed holes 22 allowing the fiber optic transmission elements to be inserted through preformed holes 22. The barricade may then be shortened by the removal of segments 40 as needed, the barricade is rotated back to the blocking position to block the unused holes.

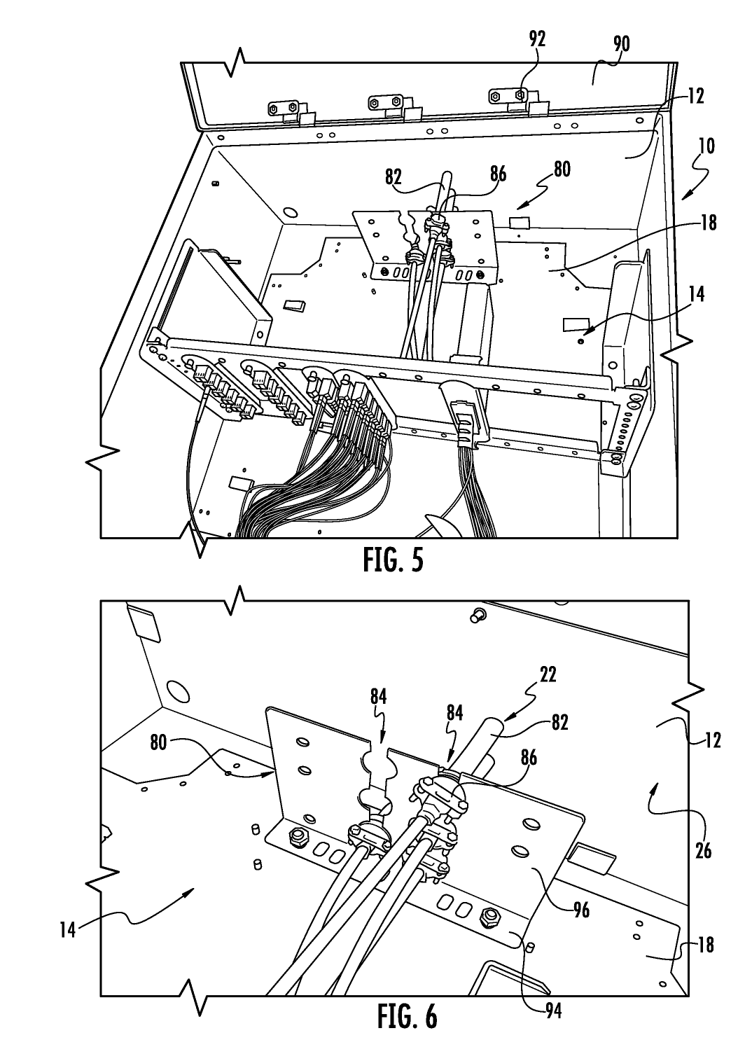

Referring to FIG. 5 and FIG. 6, cable box 10 may include another bracket, shown as stress relief bracket 80 coupled to the inner surface of bottom wall 18 located within interior cavity 14 and spaced back from inner surface 26. Optical cables 82 extend through holes 22 (note, brackets 30 and 32 and barricade 34 are shown removed in FIGS. 5 and 6). Optical cables 82 are coupled to slots 84 within stress relief bracket 80. Generally, stress relief bracket 80 supports optical connectors 86 and optical cables 82 within cable box 10. In another embodiment, outer armor layers of cables 82 may be bonded to stress relief bracket 80. To facilitate coupling of optical cables 82 within cable box 10, slots 84 of stress relief bracket 80 are substantially aligned with hole arrays 20 (and with opening 66 between brackets 30 and 32, shown in FIG. 2) such that the optical cables 82 can be assembled into cable box 10 without substantial bending of the cables. In addition, stress relief bracket 80 includes a slot 84 for each hole array 20 present in sidewall 12, and in the embodiment shown, stress relief bracket 80 includes two slots 84.

Generally, in one embodiment, stress relief bracket 80 includes a mounting section 94 coupled to bottom wall 18 and an upstanding wall 96 extending away from mounting section 94. The length of wall 96 is greater than the length of mounting section 94, and slots 84 are formed in wall 96. In the embodiment shown, stress relief bracket 80 is an L-shaped bracket and wall 96 is substantially perpendicular to mounting section 94 and to bottom wall 18, and in this embodiment, wall 96 is substantially planar and is parallel to inner surface 26 of sidewall 12.

Stress relief bracket 80 acts to support cables 82 and to anchor cables 82 within cable box 10 such that a significant amount of pull force would be required to pull cable 82 out of cable box 10 from the outside. In various embodiments, stress relief bracket 80 is configured such that more than 100 lbs. must be applied to pull cable 82 out of cable box 10 from the outside, and in another embodiment, stress relief bracket 80 is configured such that more than 50 lbs. must be applied to pull cable 82 out of cable box 10 from the outside. To provide this reinforcement, stress relief bracket 80 is formed from a sufficiently strong material, such as metal, steel, aluminum, etc.

As shown in FIG. 5 and FIG. 6, box 10 includes a door, shown as top wall or lid 90. Lid 90 is coupled to sidewall 12 via hinges 92. Lid 90 is moveable between open and closed positions providing access to interior cavity 14 of cable box 10. Cable box 10 further includes a locking mechanism (e.g., a pad lock) that locks lid 90 in the closed position to prevent unauthorized access to cavity 14 via use of lid 90.

Referring to FIG. 7, a secure cable box, shown as box 100, is shown according to an exemplary embodiment. Box 100 is substantially the same as box 10 except as discussed herein. Box 100 includes a preformed opening, shown as slot 102, formed in sidewall 12. Slot 102 is generally t-shaped and includes a wider upper portion 104 and a narrower lower channel 106.

Wider upper portion 104 provides additional space to facilitate placement of a fiber optic transmission element through slot 102 into interior cavity 14 of cable box 100. With the fiber optic transmission element positioned through wider upper portion 104, the fiber optic transmission element is slid downward into channel 106. The length of channel 106 is sufficient such that multiple fiber optic transmission elements can be stacked within slot 102. A gate 28 (such as shown in FIG. 2) is located within box 100 to block the unused portion of slot 102 following cable installation.

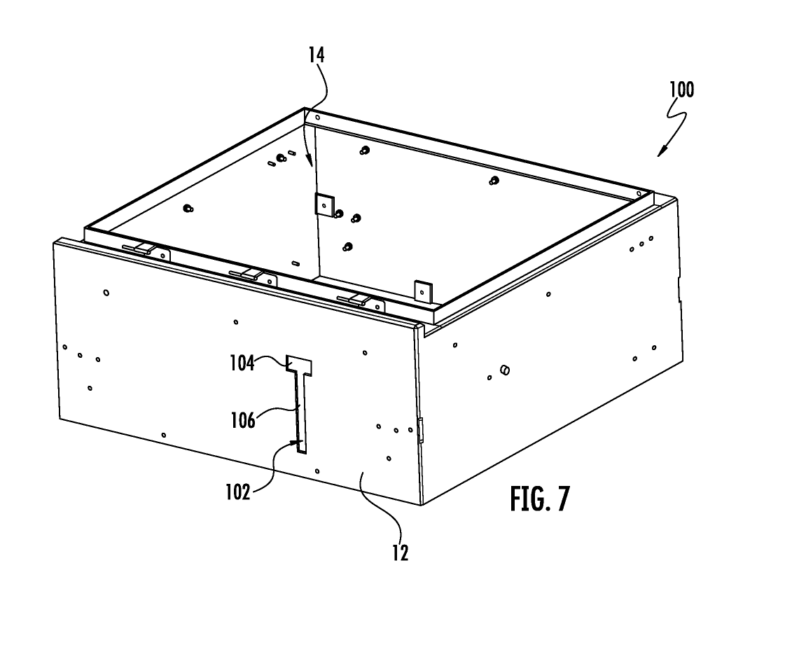

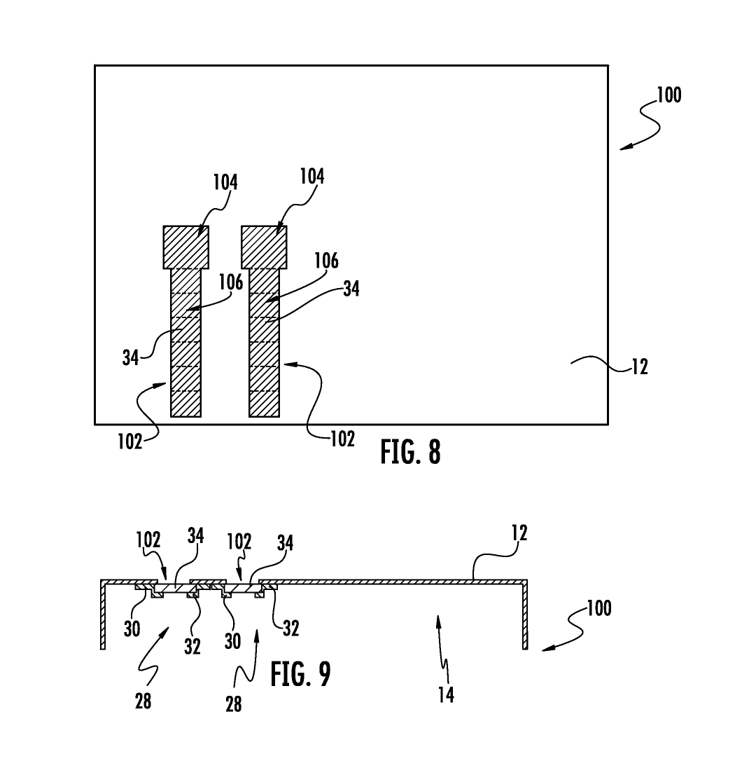

As shown in FIG. 8 and FIG. 9, box 100 may include two slots 102 formed through a single sidewall 12. In other embodiments, more than two slots 102 may be formed through the single sidewall 12. In addition, slots 102 may be formed through the other sidewalls 12. As shown in FIG. 9, each slot 102 is blocked by a gate 28, including brackets 30 and 32 and barricade 34, as discussed herein.

In the embodiment of FIG. 8, slots 102 are sized to receive six fiber optic transmission elements. In such an embodiment, the height of channel 106 of slots 102 are between 4 inches and 5 inches and more specifically is about 4.75 inches. In other embodiments, slots 102 are sized to receive other numbers of fiber optic transmission elements (e.g., 1, 2, 3, 4, 5, 7, 10, 12, etc.). In various embodiments, upper portion 104 is substantially rectangular shaped or square shaped, and in one embodiment, upper portion 104 has a width that is 20 mm plus or minus 1 mm and a height that 20 mm plus or minus 1 mm. In various embodiments, channel 106 has a width that is between 16 mm and 18 mm, and more specifically is 16.8 mm plus or minus 1 mm. In various embodiments, channel 106 has a height that is 100 mm plus or minus 1 mm, and in such embodiments the total height of slot 102 is 120 mm plus or minus 1 mm.

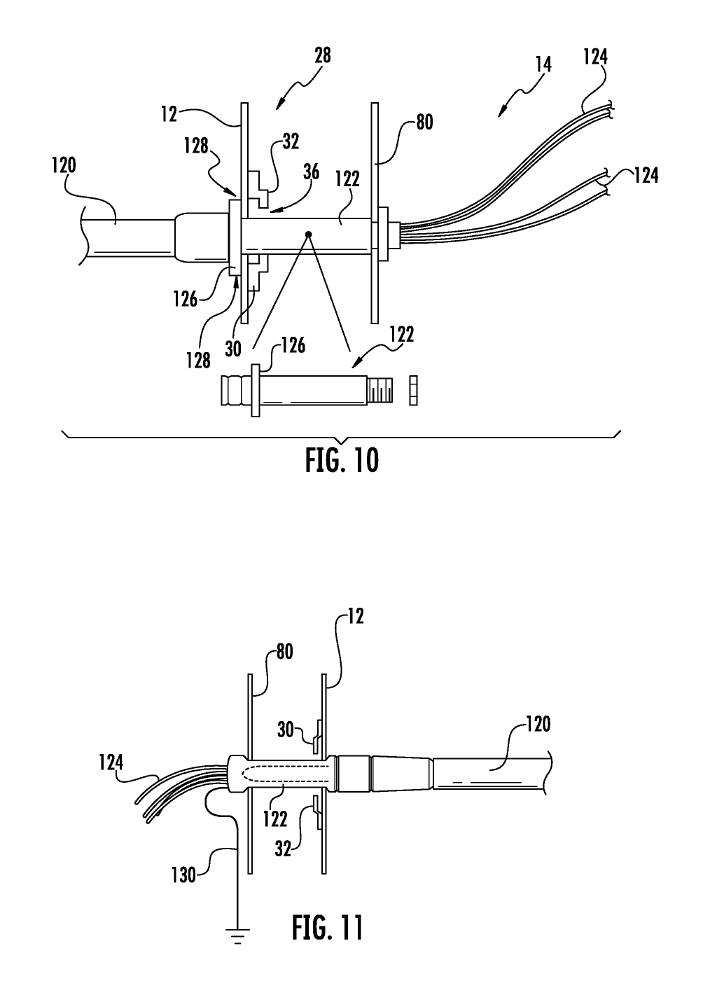

Referring to FIG. 10, an optical cable 120 and fiber optic component 122 is shown positioned through a preformed hole in sidewall 12 such that optical cable 120 and fiber optic component 122 is coupled to a cable box (e.g., cable box 10 or cable box 100 discussed herein), according to an exemplary embodiment. In the embodiment shown, fiber optic component 122 is a one-piece furcation device configured to separate out various bundles of fibers 124 (or single fibers) of cable 120 for connection and distribution within the cable box. As shown, cable 120 may include fibers 124 configured to carry data and may also include alarm fibers (e.g., Network Integrity Interceptor fibers). In the embodiment shown in FIG. 10, fiber optic component 122 is a furcation plug.

In the embodiment of FIG. 10, the front end of fiber optic component 122 is coupled to cable 120, and fiber optic component 122 extends through the preformed hole in sidewall 12. The rear end of fiber optic component 122 is coupled to stress relief bracket 80 such that the body of fiber optic component 122 extends between sidewall 12 and stress relief bracket 80. Fiber optic component 122 includes a collar 126 located at the front end of fiber optic component 122. Collar 126 extends radially outward from the body of fiber optic component 122 such that a portion of collar 126 overlaps a portion of sidewall 12 adjacent the preformed hole. Thus, by forming this overlap shown at 128, collar 126 acts to block a space or gap that may exist between the outer surface of fiber optic component 122 and the inner surface of the preformed hole. In such embodiments, collar 126 is formed from a strong or reinforced material (e.g., metal, steel, etc.) that resists or prevents unauthorized access to interior 14 of the cable box through the preformed hole after coupling of fiber optic component 122 to the preformed hole.

Referring to FIG. 11, fiber optic component 122 is shown coupled to the preformed hole in sidewall 12 and to stress relief bracket 80 of a cable box (e.g., cable box 10 or cable box 100 discussed herein), according to another exemplary embodiment. In this embodiment, fiber optic component 122 is coupled to a ground connection 130. In various embodiments, stress-relief bracket 80 (shown in FIGS. 5 and 6) is grounded and ground connection 130 is coupled to bracket 80. In one embodiment, fiber optic component 122 may include a plug and socket formation such that multiple fiber optic components 122 establish an electrical connection with the armor layer of the adjacent cables with stress relief bracket 80, and the lower most cable in the stacked array is coupled to the housing or otherwise grounded such that all cables are grounded.

In various embodiments, a method of installing a cable box into a secure fiber optic communication network is provided. At a first step, an optical fiber cable box is provided. Generally, the optical fiber cable box includes a plurality of walls defining an interior cavity and a first preformed opening extending through one of the plurality of walls. The cable box also includes a gate located in the interior cavity. At the first step, the gate is positioned in a first position adjacent an inner end of the first preformed opening such that the gate blocks the first preformed opening. In various embodiments, the cable box may be cable box 10 and/or cable box 100 discussed above.

At a second step, the gate is moved from the first position to a second position unblocking the first preformed opening. In one embodiment, the unblocking at the second step occurs without formation of a hole through a wall of the cable box, and specifically may occur without the use of a power tool such as a drill. At a third step, a fiber optic transmission element is inserted through the first preformed opening.

In additional embodiments, the gate includes a slot and a moveable barricade located in the slot, and in such embodiments, the step of moving the gate from the first position to the second position includes sliding the gate within the slot. In some embodiments, the optical fiber cable box includes a second preformed opening located above the first preformed opening, and in such embodiments, the method includes the additional step of removing a segment of the barricade to form a shortened barricade. Next, the shortened barricade is reinserted into the slot, and following the inserting step, the barricade is moved within the slot into a third position located above the fiber optic transmission element such that the shortened barricade blocks the second preformed opening.

In various embodiments, one or more fiber optics communication devices may be located within the cable box 10 or 100. In one embodiment, cable box 10 or 100 may be a zone box configured to house the equipment to split out optical fiber bundles or single fibers from a fiber optic cable out to various users. In such embodiments, the cable box may include various connector modules to split the fiber optic cable into individual fibers or to groups of fibers. In another embodiment, the cable box may be a secure desktop box containing a desktop optical network terminal In another embodiment, cable box 10 or 100 may include a power distribution unit configured to provide remote power to active network components that may be linked or installed in the cable boxes.

In various embodiments, the cable boxes discussed herein and in particular the walls of the cable boxes and the components of the gates are formed from strong materials that limit or prevent unauthorized access (e.g., by cutting, drilling, bending, breaking, etc.) into the cable box. In various embodiments, the walls of the cable boxes and the components of the gates are formed from a metal material, and may be formed from steel or aluminum or other suitably strong metal material. In various embodiments, the cable boxes discussed herein are compliant with National Security Telecommunications and Information Systems Security Instruction (NSTISSI) No. 7003.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred.

It will be apparent to those skilled in the art that various modifications and variations can be made without departing from the spirit or scope of the disclosed embodiments. Since modifications combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. A secure cable box for use within a secure fiber optic communications network comprising:
a bottom wall;
a plurality of sidewalls coupled to the bottom wall, each sidewall having an outer surface and an inner surface;
a top wall coupled to the plurality of sidewalls, wherein the bottom wall, the sidewalls and the top wall define an interior cavity, wherein the top wall is moveable between opened and closed positions to provide access to the interior cavity;
a locking mechanism configured to lock the top wall in the closed position;
a preformed opening formed through one of the plurality of sidewalls providing a passage extending between the outer surface and the inner surface of the sidewall; and
a gate located within the interior cavity adjacent an inner end of the preformed opening, the gate moveable between a first position and a second position, wherein in the first position the gate is positioned between the preformed opening and the inner cavity blocking the preformed opening and in the second position the preformed opening is unblocked.

2. The cable box of claim 1, wherein the preformed opening is an array of a plurality of individual preformed holes.

3. The cable box of claim 1, wherein the preformed opening is an elongated opening having an upper section and a lower section, wherein the width of the upper section is greater than the width of the lower section.

4. The cable box of claim 1, the gate further comprising a barricade and slot extending along the inner surface of the sidewall adjacent to the inner end of the preformed opening, wherein the barricade is slidable within the slot, wherein an outer surface of the barricade faces the inner end of the preformed opening to block at least a portion of the preformed opening when the barricade is located in the slot.

5. The cable box of claim 4, wherein the gate comprises a bracket coupled to the inner surface of the sidewall, the bracket having an outward facing surface facing the inner surface of the sidewall such that the slot is defined between the outward facing surface of the bracket and the inner surface of the sidewall.

6. The cable box of claim 1, wherein the gate includes a wall that blocks the preformed opening, the wall having at least one score line dividing the wall into a plurality of segments, each score line configured to facilitate removal of a segment of the wall.

7. The cable box of claim 1, further comprising a bracket coupled to the bottom wall such that the gate is located between the bracket and the sidewall including the preformed opening, the bracket including a slot, wherein the gate is configured to allow a fiber optic transmission element to extend through the slot, and wherein the bracket is adapted to support the fiber optic transmission element.

8. A secure cable box for use within a fiber optic communications network comprising:
a plurality of walls defining an interior cavity;
a door moveable between opened and closed positions to provide access to the interior cavity;
a preformed opening formed through one of the plurality of walls providing a passage extending between an outer surface and an inner surface of the wall, the preformed opening sized to receive a fiber optic transmission element therethrough; and
a gate located within the interior cavity adjacent an inner end of the preformed opening, the gate moveable between a first position in which the gate blocks the preformed opening and a second position in which the preformed opening is unblocked.

9. The cable box of claim 8, wherein the preformed opening is an array of a plurality of individual preformed holes.

10. The cable box of claim 8, wherein the preformed opening is an elongated slot having an upper section and a lower section, wherein the width of the upper section is greater than the width of the lower section.

11. The cable box of claim 10, the gate further comprising a barricade and slot extending along an inner surface of the wall that includes the preformed opening, the slot adjacent to an inner end of the preformed opening, wherein the barricade is slidable within the slot, and wherein an outer surface of the barricade faces the inner end of the preformed opening to block at least a portion of the preformed opening when the barricade is in the slot.

12. The cable box of claim 11, wherein the gate comprises a bracket, the bracket having an outward facing surface such that the slot is defined between the outward facing surface of the bracket and an inner surface of the wall that includes the preformed opening.

13. The cable box of claim 10, wherein the gate includes a wall that blocks the preformed opening, the wall having at least one score line dividing the wall into a plurality of segments, each score line configured to facilitate removal of a segment of the wall.

14. The cable box of claim 10, further comprising a bracket located within the interior cavity, the bracket including a slot configured to support the fiber optic transmission element, wherein the slot of bracket is aligned with the preformed opening and the gate.

15. A method of installing a cable box into a secure fiber optic communication network comprising:
providing an optical fiber cable box, the optical fiber cable box comprising:
a plurality of walls defining an interior cavity;
a first preformed opening extending through one of the plurality of walls; and
a gate located in the interior cavity, the gate positioned in a first position adjacent an inner end of the first preformed opening blocking the first preformed opening;
moving the gate from the first position to a second position unblocking the first preformed opening; and
inserting a fiber optic transmission element through the first preformed opening.

16. The method of claim 15, wherein the gate includes a slot and a moveable barricade located in the slot, wherein moving the gate from the first position to the second position comprises sliding the gate within the slot.

17. The method of claim 16, wherein the optical fiber cable box includes a second preformed opening located above the first preformed opening, the method further comprising:
removing a segment of the barricade to form a shortened barricade; and
inserting the shortened barricade into the slot; and
following the inserting step, moving the barricade within the slot into a third position located above the fiber optic transmission element such that the shortened barricade blocks the second preformed opening.

18. The method of claim 17, wherein the first preformed opening is an elongated opening having an upper section and a lower section, wherein the width of the upper section is greater than the width of the lower section.
